(19) United States
(12) Patent Application Publication
(10) Pub. No.: US 2004/0238511 A1
(43) Pub. Date: Dec. 2, 2004

(54) Method and apparatus for initiating welding arc with aid of vaporized chemical

(76) Inventors: Tim A. Matus, San Antonio, TX (US); Lin Zhang, Appleton, WI (US)

Correspondence Address: OSTRAGER CHONG FLAHERTY & BROITMAN PC, 250 PARK AVENUE, SUITE 825, NEW YORK, NY, 10177, US

(21) Appl. No.: 10/446,577

(22) Filed: May 27, 2003

(51) Int. Cl. B23K 9/06

(52) U.S. Cl. 219/130.4

(57) ABSTRACT

Methods and apparatus for initiating an arc (e.g., a welding arc) by directing a beam of electromagnetic radiation at an ionizable chemical placed on the surface of a workpiece, on the torch or some other location in proximity to the gap between the torch and the workpiece. This is done while a potential difference is applied between an electrode of the torch and the workpiece. The radiation vaporizes the chemical to form ionized gas that renders the gap between the electrode and the workpiece more conductive, thereby reducing the voltage threshold needed to initiate an arc between the electrode and the workpiece. When the voltage threshold reaches the level of the applied potential difference, the arc will be initiated.

### BACKGROUND OF THE INVENTION

This invention generally relates to methods and apparatus for starting a welding arc. In particular, the invention relates to methods and apparatus for starting a TIG welding arc.

Many methods of welding are known in the art, each with its own advantages and disadvantages. Common welding processes include gas welding, oxyacetylene brazing and soldering, shielded metal arc welding (SMAW) or “STICK” welding, gas metal arc welding (GMAW) or “wire feed” welding, gas tungsten arc welding (GTAW) or “TIG” welding, and plasma cutting. TIG welding is perhaps the cleanest, most precise of all hand-held welding operations. Although the method and apparatus of the present invention is preferably directed to a TIG welding operation, one skilled in the art will appreciate that the present invention may have applications for many other welding processes.

A conventional TIG welding process will now be described with reference to FIG. 1. In TIG welding, a concentrated high-temperature arc is drawn between a non-consumable tungsten electrode 10 and a workpiece 14, workpiece 14 being connected to the output of a welding power source (not shown) via a work clamp 24. Electrode 10 is nested in a torch 16, the torch including a shielding gas source 18, such as a cup, to direct a shielding gas 20, such as argon, helium, a mixture thereof, or other inert or non-inert gases, to a welding site 22 on workpiece 14. Torch 16 receives a flow of shielding gas 20 from a gas tank (not shown). In accordance with a known technique, the welder may strike an arc by touching or scraping the electrode 10 against the workpiece 14 to close a circuit between the electrode 10 and the work clamp 24. As electrode 10 is drawn away from the workpiece 14, an arc 12 is initiated. The welder then feeds a bare welding rod 26 to welding site 22. More precisely, the tip of the welding rod 26 is dipped into the weld puddle. The arc that crosses the gap from the electrode tip to the workpiece causes underlying workpiece material at the welding site to melt, thereby creating a molten puddle 28. During a single welding pass, the arc 12 and the welding rod 26 must be moved in unison in order to effect a weld bead. The displaced arc leaves the molten puddle 28 in its wake. The portion of the molten puddle furthest from the arc hardens continuously to leave a weld bead 30 joining two pieces of metal.

Numerous problems persist with the aforementioned physical method of striking an arc because the tip of the tungsten can contaminate the weld due to touching or scraping the electrode against the workpiece. Often, due to arcing a piece of the tip remains in the molten puddle and contaminates the weld. Also, the welder must then resharpen or replace the electrode. Not only does this process inconvenience the welder, but it also wastes time and resources, which ultimately imparts a higher cost to each weld.

One known solution to the above problems has been to use a high-frequency signal to initiate and maintain the arc. A high-frequency signal ionizes the shielding gas, allowing the welding power to jump the gap between electrode and workpiece. However, high frequency, too, has its drawbacks. The high-voltage, low-amperage noise from the high-frequency circuitry often causes electrical interference with surrounding equipment, making its use unacceptable in certain applications. Also, the high-frequency signal can be tough on TIG torches and work leads because the high voltage causes a stress to be applied to the insulation of the weld cables.

Another arc starting method that avoids the problems associated with the scratch start is the “lift” arc method. Lift arc starting involves touching the electrode to the workpiece without the necessary scraping to generate a spark. Some known lift arc methods utilize a separate low-current power circuit, in addition to the power circuits already present in a welding device, to create a small monitoring voltage between the electrode and work clamp. Control circuitry monitors the voltage between the electrode and work clamp and, when a short is detected (i.e., the electrode has been touched to or brought in close proximity with the workpiece), enables the power circuit to provide an initial regulated current to warm, but not melt the electrode. When the control circuitry detects a significant torch-to-workpiece voltage (i.e., the electrode is no longer touching or is not in close proximity to the workpiece), the control circuitry enables the power circuit to provide full user-selected welding power. However, the separate power circuit required to provide the small monitoring voltage leads to additional cost and complexity of the circuitry in the welding power source. Furthermore, some lift arc start methods fail to reliably regulate the output current level before and after the short is detected. An improved “lift” arc technique, directed to overcoming the foregoing disadvantages, is disclosed in U.S. Pat. No. 6,034,350. Still some welding procedures require that the tungsten not touch the workpiece.

Another known solution, disclosed in U.S. Pat. No. 6,075,224, is to start a welding arc by applying an arc starting signal to ionize the shielding gas before enabling welding output power. The welding device disclosed in U.S. Pat. No. 6,075,224 comprises a power circuit to provide welding power, a shielding gas source to provide a shielding gas at a welding site disposed between an electrode and a workpiece, an arc starter circuit (e.g., a high-frequency start circuit) to apply an arc starting signal to ionize the gas, and a controller coupled to a control input of the power circuit. The arc starting steps are also controlled by the controller. First, the controller enables a flow control meter to begin supplying shielding gas to the welding site. When the pre-flow period has expired, the controller enables the arc starter circuit, which generates an arc starting signal that is provided to the power output for a predetermined period of time during which the resulting arc ionizes the flow of shielding gas particles. The starting arc is not suitable for welding. A predetermined time after the arc starting signal is applied, the controller enables the power circuit such that welding power is provided and an arc suitable for welding is drawn between the electrode and the workpiece.

There is an ongoing need for further improvements in methods and apparatus for initiating and maintaining a TIG or other welding arc.

### BRIEF DESCRIPTION OF THE INVENTION

The invention is directed to methods and apparatus for initiating an arc (e.g., a welding arc) by directing a beam of electromagnetic radiation at an ionizable chemical placed on the surface of a workpiece. This is done while a potential difference is applied between an electrode and the workpiece that are separated by a gap. The radiation vaporizes the chemical to form ionized gas that renders the gap between the electrode and the workpiece more conductive, thereby reducing the voltage threshold needed to initiate an arc between the electrode and the workpiece. When the voltage threshold reaches the level of the applied potential difference, the arc will be initiated.

One aspect of the invention is a method of initiating an arc between an electrode and a workpiece separated by a gap, comprising the following steps: applying a potential difference between the electrode and the workpiece; placing a chemical that produces ions when vaporized in the vicinity of or near the gap; and directing a laser beam toward the chemical with sufficient power to vaporize enough chemical to produce an arc between the electrode and the workpiece at the applied potential difference.

Another aspect of the invention is a method of initiating an arc between an electrode and a workpiece separated by a gap, comprising the following steps: applying a potential difference between the electrode and the workpiece; placing an ionizable chemical in the vicinity of or near the gap; and directing sufficient electromagnetic radiation onto the ionizable chemical to vaporize chemical in an amount that causes an arc to be produced between the electrode and the workpiece at the applied potential difference.

A further aspect of the invention is an apparatus comprising: an electrode comprising a tip; a shield surrounding the electrode to form a passageway therebetween; and a laser disposed to transmit a laser beam along a line that generally intersects an axis of the electrode at a position below the tip of the electrode.

Yet another aspect of the invention is a system comprising: an electrode comprising a tip; a workpiece comprising a surface area separated from the tip of the electrode by a gap and covered by an ionizable chemical; a power circuit for applying a predetermined potential difference between the electrode and the workpiece; and a beam transmitter for transmitting a beam of electromagnetic radiation at the ionizable chemical on the surface area.

A further aspect of the invention is a method for initiating an arc between an electrode and a workpiece separated by a gap, comprising the following steps: placing an ionizable chemical in solid form on a surface area of the workpiece confronting the electrode; applying a potential difference between the electrode and the workpiece; and vaporizing enough of the ionizable chemical to produce an arc between the electrode and the workpiece at the potential difference.

Other aspects of the invention are disclosed and claimed below.

### BRIEF DESCRIPTION OF THE DRAWINGS

FIG. 1 is a drawing illustrating a conventional TIG welding operation, described in the Background of the Invention section.

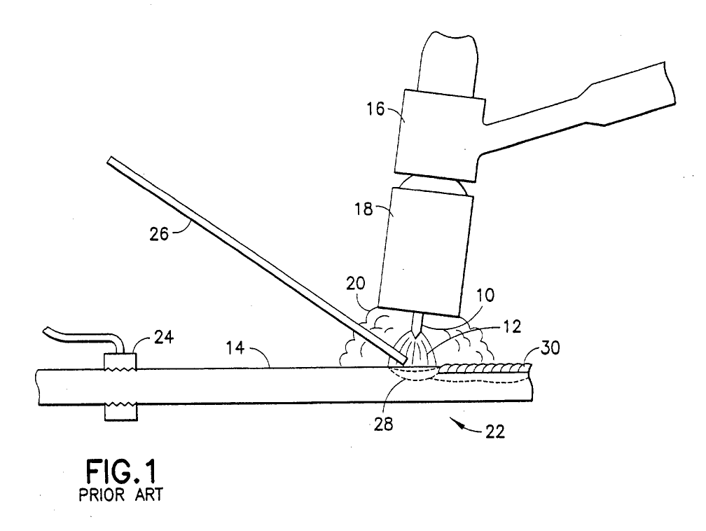

FIG. 2 is a drawing showing a partial sectional view of an apparatus comprising a laser and a TIG welding torch in accordance with one embodiment of the present invention.

Reference will now be made to the drawings in which similar elements in different drawings bear the same reference numerals.

### DETAILED DESCRIPTION OF THE INVENTION

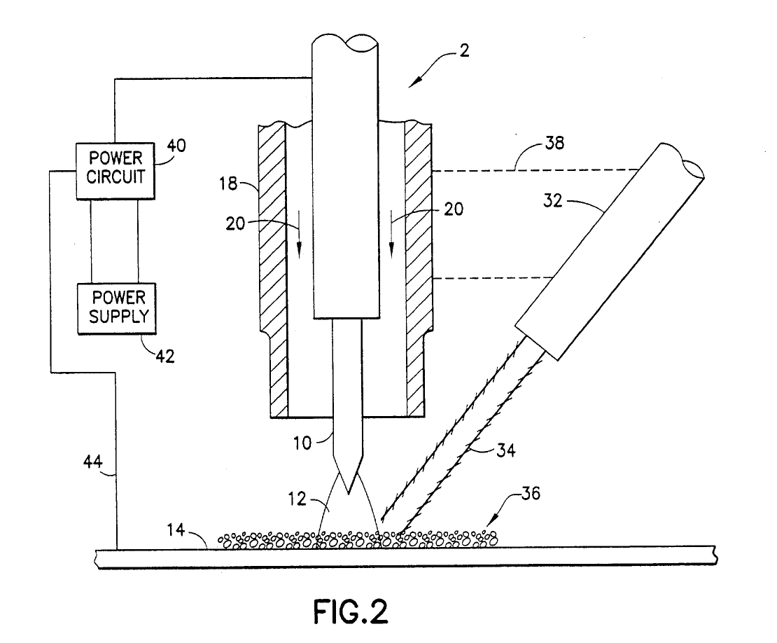

The basic concept of the invention is illustrated in FIG. 2, which shows a setup for TIG welding arc initiation. The workpiece 14 is positioned with the welding site disposed directly underneath the tip of a tungsten electrode 10 of a TIG welding torch 2. The electrode 10 receives electrical power from a power supply 42 via a power circuit 40. When the power circuit 40 is turned on, the power supply 42 produces a difference in the electric potentials at the electrode 10 and the workpiece 14 respectively. During welding arc formation, the electrode 10 receives current via the power circuit 40. A workpiece lead 44 provides a return path for the current and is typically connected to the workpiece 14 by a clamp (not shown). In the absence of an arc, current does not flow through the electrode and the workpiece.

The TIG welding torch 2 further comprises a generally circular cylindrical gas cup or shield 18 that surrounds and is generally coaxial with the electrode 10. The cup 18 defines the outer boundary of a generally annular passageway through which a shielding gas, such as argon, helium, a mixture thereof, or other inert or non-inert gas, flows. The shielding gas flow is indicated by arrows 20 in FIG. 2. The shielding gas is conveyed to the welding torch from a gas supply tank by means not shown, which means typically include a cable that connects the welding torch to the power supply unit. Typically the cable carries both shielding gas and electric power to the welding torch.

To initiate an arc in accordance with one embodiment of the invention, the flow of shielding gas is turned on, and a potential difference between the electrode 10 and the workpiece 14 is applied. Initially, the conditions are such that an arc is not initiated, i.e., the resistance across the gap separating the tip of electrode 10 and the workpiece 14 is too great relative to the potential difference or voltage being applied. The present invention employs means for increasing the conductivity of the gap to a point whereat the arc will be initiated at the applied voltage.

FIG. 2 depicts an instant in time immediately following initiation of a welding arc 12 between the electrode 10 and the workpiece 14. In accordance with the embodiment depicted in FIG. 2, the welding arc is initiated with the aid of a laser 32, shown disposed at an oblique angle relative to both the TIG welding torch 2 and the workpiece 14. The laser 32 operates in conventional fashion to generate a beam 34 of substantially monochromatic electromagnetic radiation, which is typically in the optical or infrared range. The laser beam 32 is directed toward the top surface of the workpiece 14 in the area underlying the tip of the tungsten electrode 10. The laser 32 may be held and aimed by the welder or may be supported in a fixed positional relationship with the TIG torch, e.g., by means of a support member 38, the ends of which are welded or clamped to the gas cup 18 and to the laser 32 respectively.

In accordance with one embodiment of the invention, the area under the electrode is covered with solid matter 36 in particulate form. The solid matter 36 comprises a chemical having the property of being ionizable when exposed to electromagnetic radiation of sufficient power. In other words, in this embodiment the laser beam is strong enough to induce ionization of the chemical. Two examples of suitable materials are sodium carbonate and potassium dichromate. However, the invention is not limited to use of these specific chemicals.

In accordance with this embodiment, the laser beam 34 is directed at the particulate matter 36, causing the chemical to vaporize. During vaporization, the atoms of the molecules disassociate to form positive and negative ions, with the positive ions (e.g., sodium ions in the case of sodium carbonate and potassium ions in the case of potassium dichromate) flowing toward the electrode. The resulting ionized gas renders the space between the electrode and the workpiece sufficiently conductive, relative to the applied voltage, that an arc 12 can be initiated.

The person skilled in the art will appreciate that in order to initiate an arc, other factors being constant, the conductivity of the gap must increase as the potential difference across the gap is decreased. The applied open-circuit voltage may be on the order of 80 volts, but any other voltage sufficient for TIG welding can be applied during arc initiation.

In accordance with the embodiment shown in FIG. 2, a welding arc is initiated between the tungsten electrode 10 and the workpiece 14 by placing an ionizable chemical 36 in particulate form on the surface of the workpiece 14; holding the TIG torch 2 in a position wherein the tip of the tungsten electrode 10 is directed toward the chemical 36 and is separated from and not in contact with the workpiece 14; turning on the shielding gas flow 20; applying a potential difference between the electrode 10 and the workpiece 14; and then directing a laser beam 34 toward the chemical 36 disposed underneath the electrode tip. The energy injected by the laser beam 34 causes the chemical 36 to vaporize and ionize. This laser-induced generation of ions increases the conductivity of the gaseous medium in the space separating the TIG electrode 10 and the workpiece 14. This, in turn, has the effect of reducing the voltage threshold at which an arc between the electrode tip and the workpiece will be produced. For example, the potential difference initially applied between the tungsten electrode 10 and the workpiece 14 is less than the voltage threshold required to initiate an arc when the ionized gas is not present, but greater than or equal to the voltage threshold required to initiate an arc when the ionized gas is present. Thus, by directing the laser beam 34 onto the chemical 36 on the surface of the workpiece 14, a welding arc 12 can be initiated.

In the case wherein the chemical 36 is in the form of particulate matter placed on the workpiece, the weight of the particles must be great enough that the particles are not blown away by the shielding gas. However, the invention is not limited to the placement of a chemical compound in powder form on the workpiece. The chemical may alternatively be applied in a solid state on the torch or placed or applied on some other substrate in the vicinity of the gap between the electrode and the workpiece. Also the chemical may be sprayed into the gap in either solid or liquid form, e.g., from a sprayer mounted to the torch. In its broadest scope, it is only necessary that a laser beam be directed onto a suitable chemical (in solid or liquid form) placed sufficiently close to the gap that vaporized chemical flowing into the gap increase the conductivity of the gap sufficiently.

While the invention has been described with reference to preferred embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

1. A method of initiating an arc between an electrode and a workpiece separated by a gap, comprising the following steps:
applying a potential difference between the electrode and the workpiece;
placing a chemical that produces ions when vaporized in the vicinity of or near the gap; and
directing a laser beam toward the chemical with sufficient power to vaporize enough chemical to produce an arc between the electrode and the workpiece at said potential difference.

2. The method as recited in claim 1, wherein said placing step comprises placing the chemical on the workpiece.

3. The method as recited in claim 2, wherein the chemical is placed on the workpiece in the form of a powder.

4. The method as recited in claim 1, wherein said placing step comprises placing the chemical on the torch.

5. The method as recited in claim 1, wherein said placing step comprises spraying the chemical, in liquid or particle form, into the path of the laser beam.

6. The method as recited in claim 1, wherein the chemical is potassium chromate.

7. The method as recited in claim 1, wherein the chemical is sodium carbonate.

8. The method as recited in claim 1, further comprising the step of causing shielding gas to flow toward the workpiece and around the tip of the electrode during arc initiation.

9. A method of initiating an arc between an electrode and a workpiece separated by a gap, comprising the following steps:
applying a potential difference between the electrode and the workpiece;
placing an ionizable chemical in the vicinity of or near the gap; and
directing sufficient electromagnetic radiation onto the ionizable chemical to vaporize chemical in an amount that causes an arc to be produced between the electrode and the workpiece at said potential difference.

10. The method as recited in claim 9, wherein said placing step comprises placing the ionizable chemical on the workpiece.

11. The method as recited in claim 10, wherein the ionizable chemical is placed on the workpiece in the form of a powder.

12. The method as recited in claim 9, wherein said placing step comprises placing the ionizable chemical on the torch.

13. The method as recited in claim 9, wherein said placing step comprises spraying the ionizable chemical, in liquid or particle form, into the path of the laser beam.

14. The method as recited in claim 9, wherein the ionizable chemical is potassium chromate.

15. The method as recited in claim 9, wherein the ionizable chemical is sodium carbonate.

16. An apparatus comprising:
an electrode comprising a tip;
a shield surrounding said electrode to form a passageway therebetween; and
a laser disposed to transmit a laser beam along a line that generally intersects an axis of said electrode at a position below said tip of said electrode.

17. The apparatus as recited in claim 16, further comprising means for supporting said electrode and said laser in a fixed positional relationship.

18. A system comprising:
an electrode comprising a tip;
a workpiece comprising a surface area separated from said tip of said electrode by a gap and covered by an ionizable chemical;
a power circuit for applying a predetermined potential difference between said electrode and said workpiece; and
a beam transmitter for transmitting a beam of electromagnetic radiation toward said ionizable chemical on said surface area.

19. The system as recited in claim 18, wherein said beam transmitter comprises a laser.

20. The system as recited in claim 18, wherein said beam is substantially monochromatic.

21. The system as recited in claim 18, wherein said predetermined potential difference is insufficient to produce an arc between said electrode and said workpiece in the absence of said beam of electromagnetic radiation.

22. The system as recited in claim 18, wherein said beam has sufficient power to ionize said ionizable chemical to a degree sufficient to produce an arc between said electrode and said workpiece at said predetermined potential difference.

23. The system as recited in claim 18, wherein said ionizable chemical is potassium chromate.

24. The system as recited in claim 18, wherein said ionizable chemical is sodium carbonate.

25. A method for initiating an arc between an electrode and a workpiece separated by a gap, comprising the following steps:
placing an ionizable chemical in solid form on a surface area of the workpiece confronting the electrode;
applying a potential difference between the electrode and the workpiece; and
vaporizing enough of the ionizable chemical to produce an arc between the electrode and the workpiece at said potential difference.

26. The method as recited in claim 25, wherein said vaporizing step comprising causing a laser beam to impinge on the ionizable chemical.

27. The method as recited in claim 26, wherein the ionizable chemical is potassium chromate.

28. The method as recited in claim 26, wherein the ionizable chemical is sodium carbonate.
